(19) United States
(12) Patent Application Publication
(10) Pub. No.: US 2013/0121155 A1
(43) Pub. Date: May 16, 2013

(54) METHOD AND APPARATUS FOR CHANGING BETWEEN TRANSMISSION STATES IN A COMMUNICATION SYSTEM

(71) Applicant: FUJITSU LIMITED, Kawasaki-shi (JP)

(72) Inventors: Rajni Agarwal, Northwood (GB); Kevin Power, West Drayton Middlesex (GB); Sunil Keshavji Vadgama, Ashford Middlesex (GB)

(73) Assignee: FUJITSU LIMITED, Kawasaki-shi (JP)

(21) Appl. No.: 13/713,143

(22) Filed: Dec. 13, 2012

Related U.S. Application Data
(63) Continuation of application No. PCT/EP2010/059315, filed on Jun. 30, 2010.

(51) Int. Cl. H04W 28/08

(52) U.S. Cl. CPC H04W 28/08
USPC 370/236

(57) ABSTRACT

A controller for use in a wireless telecommunications system, the telecommunications system including one or more base stations, the one or more base stations being operable to wirelessly transmit data to user equipments in a first transmission state having a first capacity and in a second transmission state having a second, higher, capacity, the one or more base stations also being operable to change between transmission states in response to a transmission state change instruction from the controller, the controller comprising a transmission state management unit operable to apply a threshold mechanism to a value representing current data load, and if the threshold mechanism is satisfied, to issue a transmission state change instruction to change between the two transmission states, wherein a transition point of the threshold mechanism for a transition from the first to the second transmission state is set independently from a transition point for a transition from the second to the first transmission state.

This invention is in the field of telecommunications and relates to energy efficient utilisation of base stations in a wireless network. The invention may be applied to any CDMA or OFDMA mobile systems, in particular 3GPP-LTE, WCDMA, 802.16e-2005, and 802.16m.

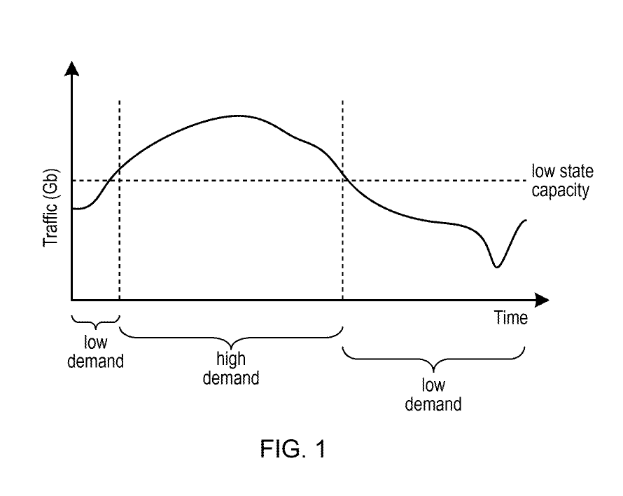

The radio network planning at the design stage of CDMA- or OFDMA-based mobile systems such as, 3GPP-LTE, WCDMA, 802.16e-2005 and 802.16m is primarily based on coverage and data throughput capacity requirements of the network. Furthermore, such network planning also takes into account the available radio resources, for example, the carrier bandwidth, allowable MIMO modes, and so on, to derive the peak system capacity. Since the network planning is carried out for the worst case (or maximum) data traffic demand scenario, it implies that if the data traffic load on the network reduces during certain time instances, some of these available resources may be scaled down, thus reducing the data traffic capacity, in order to achieve energy saving while still being able to serve the network's present data traffic load. FIG. 1 is a graph illustrating how the traffic in a system may vary over time, and in particular includes a line low capacity' representing the capacity of the system when the available resources have been scaled down.

A few examples of such radio resource scaling are provided below and the system may use any one or a combination of more than one of these schemes to design an Energy Efficient Network:

(i) Switch off certain base-stations during periods of reduced traffic load where all the sites operate with the same RAT technology (E.g. LTE-LTE Multi-state network).
(ii) Switch off an overlay network during periods of reduced traffic load where coverage is provided to a network region by means of overlaid networks operating with different RAT technology (e.g. 3G-LTE Overlay Network).
(iii) Scale the bandwidth from 20 MHz to 5 MHz in an OFDMA based system for two different values of traffic load corresponding to system capacity at respective bandwidths. This can provide energy saving due to reduced radio frequency output power.
(iv) Reduce the number of sectors per site during periods of reduced traffic load so as to achieve energy saving due to having fewer transmitters in operation.
(v) Scale the number of MIMO transmit antennas during periods of reduced traffic load so as to achieve energy saving due to reduced transmit power.

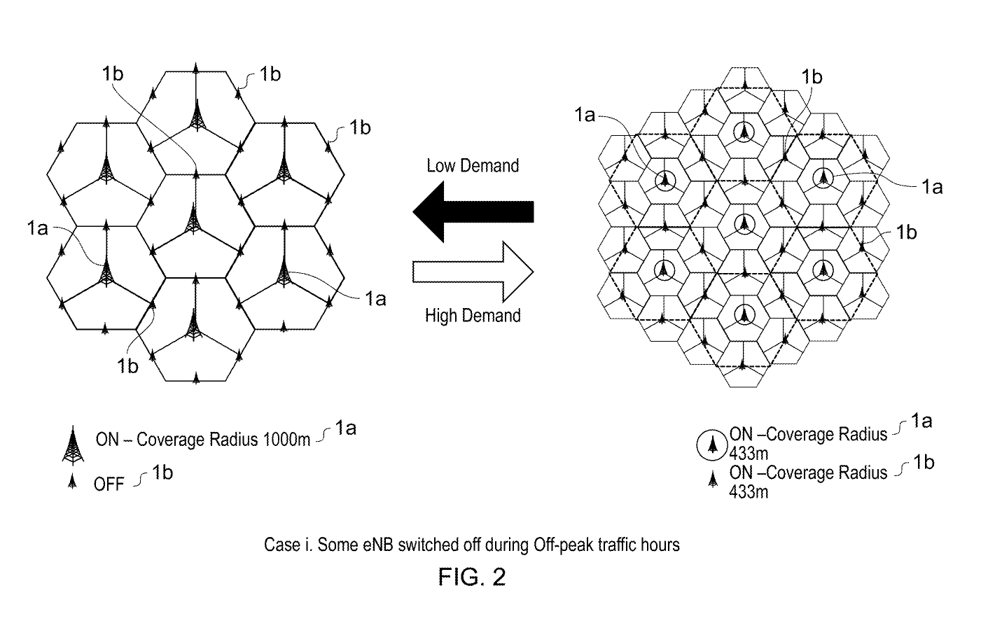

FIG. 2 provides an illustrative example of case (i), in which certain base stations 1b are turned on when there is high traffic load (high demand) in the system (traffic load exceeds low capacity), and turned off when there is low traffic load (low demand) in the system (traffic falls below low capacity). Certain base stations, 1a, remain on in either state, but must increase their coverage (the geographical area intended to be served by the base station) during times of low demand to compensate for the base stations 1b being turned off. The base stations that remain on in each state are circled in the right hand diagram.

In response to the current traffic load, the system in case (i) operates in two states: State High whereby all the base stations 1a, 1b, are active to be able to meet high traffic load and State Low whereby some of the base stations 1b are switched off with the remaining base stations 1a being able to meet the reduced traffic load. Note that the two different states may apply to a group of sites in case (i), i.e. a number of base stations may have to be considered collectively for state transition. Thus the base stations 1a that remain ‘active’ during State Low need to able to support the load of all user equipments from neighbouring ‘Switched OFF’ cells (geographical areas intended to be served by particular base stations).

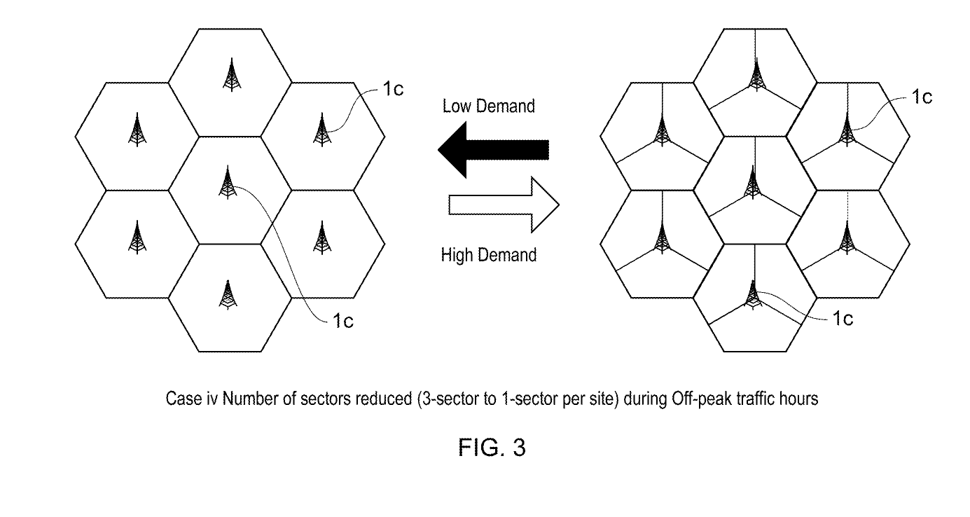

FIG. 3 illustrates case (iv), in which base stations 1c remain switched on during periods of both high and low traffic load, however, in times of low demand they are in a State Low whereby the cell is not split into sectors, and in times of high demand they are in a State High whereby the cell is split into three sectors. Power consumption is reduced in State Low since fewer antennas are required. Capacity is higher in State High than in State Low.

In other words, the system in case (iv) operates in two states: State High whereby each base station 1c has three-sectored configuration to be able to meet high traffic demand and State Low whereby each base station 1c only has a single omni-directional transmitter for a lower traffic demand. Note that the two different states may apply to individual base stations 1c in case (iv), i.e. each base-station can independently transition its state based on its individual design capacity and local traffic load. Due to the repetition of cells in FIGS. 2 and 3 not all base stations are labelled, however it is clear from the illustrations which base stations are categorised 1a, 1b, and 1c.

The options provided in cases (i) to (v) listed above are not exhaustive and there may be other cases where the available radio resources and hence the available system capacity is reduced by some means during reduced traffic load thus realizing reduction in power consumption. The magnitude of such a reduction varies from scheme to scheme and will also be dependent on the network conditions as well as equipment specifications. Moreover, not all the schemes may be applicable in all network scenarios. For example, the use case (i) and (iv) may only be applied for regions which have been planned with a capacity constraint, for example Dense-Urban, Urban or Sub-urban. This is so that when certain base-stations are switched off, the coverage does not get impacted or can be maintained by simply adapting the transmit parameters (power and downtilt). In rural areas, the constraints may be coverage-based, so that regardless of traffic load, all base stations must remain switched on in order to maintain geographical coverage at a particular level.

Each of the above use-cases may have two or more states whereby the system's peak design capacity is different for each state. The transition from any higher state (having a higher capacity denoted by CapH) to next lower state (having a lower capacity denoted by CapL) or vice versa will be typically determined by the value of ‘CapL’. A system in this context may include a single base station, or a group of base stations.

A network or system planned to support any such form of resource scaling as a function of traffic load can lead to savings in power consumption thereby reducing the carbon footprint as well as OPEX (operational expenditure) for the operators.

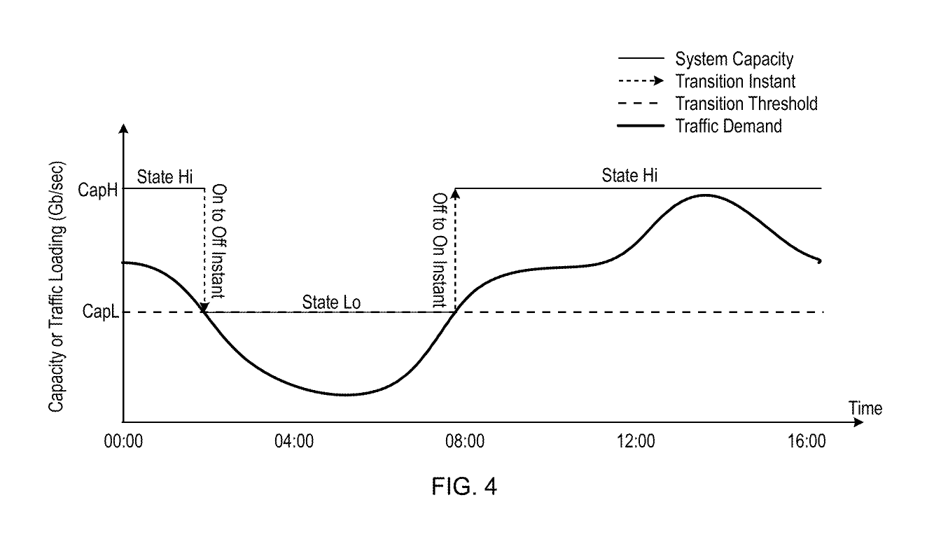

In order to implement such an energy efficient system with two or more states of operation where each state is designed to serve a certain ‘peak’ traffic demand, one of the key elements is the determination of instant for the transition from State High→Low or Low→High. In general, if a threshold is defined for transition, then the current live traffic load, or at least a value representing the current live traffic load, can be compared against such a threshold to determine if the trigger should be activated for the transition. Taking the example of the two state system of FIG. 4, assume that the capacity corresponding to State High is denoted by CapH and that corresponding to State Low is CapL. This capacity value may relate to that of a single base-station or collectively to a group of base-stations depending on the use-case under consideration. To enable the system to change the state from High to Low when the traffic demand is low, it would be possible to compare the traffic loading of the system with a threshold. The threshold in this case would be set to CapL, or just below CapL. Thus whenever the system is in state high and the traffic falls below the threshold the state transition to Low is achieved by either switching off a few base-stations 1b (case i) or by changing the site configuration of the one or more base stations 1c from 3-sector to single sector (case iv).

In all these cases it is desirable to provide a suitable determination of the trigger instant for a transition between states.

A first aspect of the present invention provides a controller for use in a wireless telecommunications system, the telecommunications system including one or more base stations, the one or more base stations being operable to wirelessly transmit data to user equipments in a first transmission state having a first capacity and in a second transmission state having a second, higher, capacity, the one or more base stations also being operable to change between transmission states in response to a transmission state change instruction from the controller, the controller comprising a transmission state management unit operable to apply a threshold mechanism to a value representing current data load, and if the threshold mechanism is satisfied, to issue a transmission state change instruction to change between the two transmission states, wherein a transition point of the threshold mechanism for a transition from the first to the second transmission state is set independently from a transition point for a transition from the second to the first transmission state.

A further aspect of the invention provides a wireless telecommunications system, the telecommunications system including one or more base stations and a controller, the one or more base stations being operable to wirelessly transmit data to user equipments in a first transmission state having a first capacity and in a second transmission state having a second, higher, capacity, the one or more base stations also being operable to change between these transmission states in response to a transmission state change instruction from the controller. The controller comprises a transmission state management unit operable to apply a threshold mechanism to a value representing current data load, and if the threshold mechanism is satisfied, to issue a transmission state change instruction to change between the two transmission states, wherein a transition point of the threshold mechanism for a transition from the first to the second transmission state is set independently from a transition point for a transition from the second to the first transmission state.

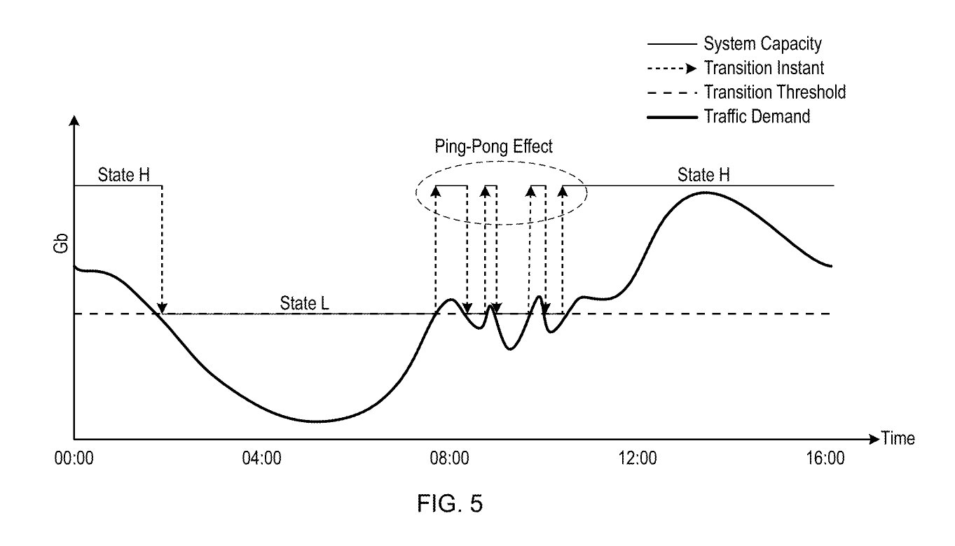

The inventors have come to the realisation that in reality, the traffic load is very likely to contain temporal variations which can cause instability in the state transition (i.e.: causing undesirable multiple High→Low, Low→High transitions) when the traffic load of the system is near the threshold point, as illustrated in FIG. 5 at the section denoted ‘Ping-Pong Effect’. The ‘Ping-Pong Effect’ is a rapid switching between two states. This is undesirable because, depending on the scheme that is employed for state transition, each scheme may involve procedures like a handover of a number of UEs (user equipments) to neighbouring base stations (example cases (i) and (ii)), or the UEs within the system having to undergo reconnection procedures to their current base station (example cases (iii) and (iv)). These procedures will have an impact on the power consumption of both eNBs and UEs, will involve a control signalling overhead, may affect or interfere with scheduling algorithms during the state transition, and generally add to the instability of system operation.

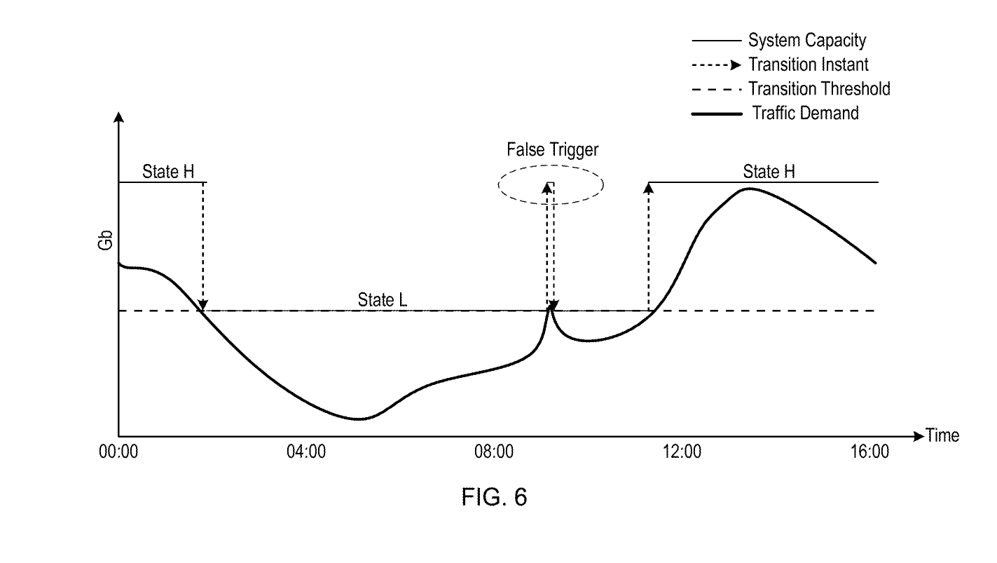

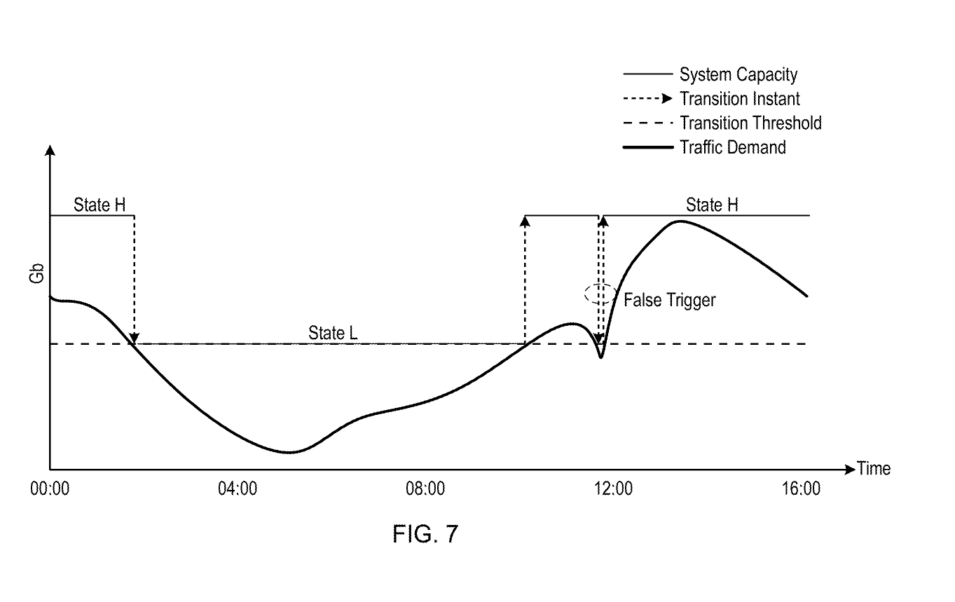

A further undesirable effect of a multi-transmission state system which has come to the inventors' attention can be the ‘false trigger’ effect, illustrated in FIGS. 6 (state low to high) and 7 (state high to low). The False Trigger problem type is described in FIG. 6 where a pulse-like traffic activity leads to the transition of states from state low to state high. It is important for the system to adapt to un-expected variations in traffic demands. However, it is also desirable to determine whether the variation in traffic demand is significant enough to warrant a transition in state. If the variation is small (either temporally or in amplitude or both) as depicted in FIG. 6, then it may not be necessary to perform the transition. Similarly, a false trigger may also appear for reverse transition as shown in FIG. 7.

Desirably, a controller or system according to invention embodiments provides a more robust threshold mechanism than a simple single threshold level at the border between two states to ensure better control for the network or system operator and stable network operation.

The provision of a threshold mechanism having transition points which are set independently for a transition from a low to high transition and for a high to low transition, as provided for in the present invention, can for example result in a system having a tendency to remain in its current transmission state which improves stability of the transmission state of the system.

Setting two transition points independently may mean that at least one thresholding element of the transition point, such as a value, duration, parameter, or proportion, is different between the two transition points. Alternatively, the result of independent setting may lead to two identical transition points.

The controller may be considered to be a functional unit which may include a processor and a memory, or it may be that the functionality of the controller can be provided by some other means. Optionally, the controller may not be a single device or its functionality provided by a single device. For example, more than one distinct device or unit may together provide the controller functionality.

Preferably, a controller has the functionality to transmit an instruction to the or each base station as required to initiate a change of transmission state. Alternatively, the controller may be integral in the base station (or one of the base stations), in which case no such transmission is required. It may be that the controller simply issues the instruction and a separate unit or device is responsible for its transmission if required. The controller, or indeed the base stations themselves, may have a signalling interface allowing communication between controllers and base stations.

The transmission states may be neighbouring states. That is to say, when the possible transmission states of one or more base stations are placed in order of capacity, the first and second transmission states are adjacent. A transmission state may be defined as a transmission parameter value (in which case other transmission parameter values can be constant/pre-defined) or as a set of values of transmission parameter values. Suitable transmission parameter values include for example, one or more of the tilt of an antenna, a transmit power, whether particular antennas are switched on or off, a mask to be applied to an antenna or antenna array, the bandwidth at which an antenna transmits, and so on. The value or set of values will have an associated upper capacity limit, probably in the form of a maximum rate of system data throughput which can be supported. Optionally, a base station or group of base stations collectively will have only two possible transmission states, but it may be that the system has more than two transmission states. It is implicit that the base station or group of base stations can only be in one transmission state at any point in time, although there may be a finite transitional period between two states.

The capacity of a transmission state may be taken to be the maximum system data throughput rate when the one or more base stations are in that transmission state. The system considered for data throughput rate may comprise a single cell or sector or base station or a group of cells or sectors or base stations. Furthermore, the data throughput rate may apply to uplink or downlink or both. Capacity of a transmission state may be measured at the edge of a cell or group of cells served by the base station or group of base stations respectively, since this is where capacity tends to be lowest. However, it is also possible that a capacity of a transmission state is calculated on a theoretical basis depending on the encoding and data transmission procedures in the network in question.

The one or more base stations are generally considered to be in a particular transmission state (or mode) when their transmission parameters are configured according to a set of values defined for that transmission state.

The value representing current data load may be based on the amount of data the base station or group of base stations is required to send to, or receive from, user equipments in a given time period. For example the value may relate to buffer contents of the one or more base stations. Appropriate measurements may be taken or recorded in any suitable way, for example as a rate or an absolute value over a set period of time. The value representing current data load is not necessarily instantaneous and may be based on a certain number of the most recent measurements of data load with the highest value given as the current value, or an average or weighted average may be used. The base station or group of base stations may not necessarily be able to transmit the data traffic at a required rate in the current transmission state. That is to say, the data which the base station or group of base stations is required to send can still exceed an upper capacity limit of the current transmission state.

The current data load may be the current data traffic load of a single base station, a particular base station out of more than one base stations, any base station out of more than one base stations, or there may be some threshold mechanism parameter related to a transmitter percentage, such as a certain proportion of a group of more than base stations must have a value representing current data load at a level sufficient to satisfy the threshold mechanism.

The transition point is a set of one or more thresholding elements, for example, parameters setting transmission performance values (e.g. data throughput, rate of change of data throughput, time data throughput has been at or above a certain level) at which the threshold mechanism is satisfied. The transition point may be a value or range of values of one or more thresholding elements, and hence may be considered to be a transition range or transition area. For consistency, we shall use the term ‘transition point’ in this document, on the understanding that this term is not limited to only one possible value or set of values.

In invention embodiments, the data load and transition point values relating to data load may be an aggregate of all data types, or alternatively, the data load and transition point values may relate to particular types of traffic depending on QoS, QoE, and SLA constraints. For example, the data load and transition point values may only apply to data having particular QoS requirements, such as guaranteed bit rate, and hence the threshold mechanism and switching between transmission states is carried according to the data load only of data having a particular, or particular range of, guaranteed bit rate. An alternative QoS requirement delimiting data to which the threshold mechanism is applied and hence state transitions are based on is delay-constrained traffic, for example, data having a maximum permissible delivery delay.

In preferred embodiments, the transition points are set taking into account a threshold value representing current data load, which is higher if the present transmission state is the first transmission state than if the present transmission state is the second transmission state. For example, the transition points may be set such that the threshold mechanism is satisfied at a different level of current data load in the one or more base stations, depending upon a current transmission state in the network.

The threshold mechanism may simply be a comparison between a value representing current data load and a threshold value as a transition point, but crucially, the threshold mechanism incorporates a dependency on the current transmission state of the base station or group of base stations. In this way, there exists a range of data load values, between the transition point at which the threshold mechanism is satisfied for transmission from the lower into the higher state, and the transition point at which the threshold mechanism is satisfied for transmission from the higher into the lower state, at which the base station or group of base stations can be in either of two transmission states without necessarily giving rise to a transition, depending on the history of the data load values. This dependence on historical values introduces some hysteresis to the threshold mechanism which increases the stability of the transmission states compared to a simple single threshold between neighbouring states.

Optionally, the transition points are set taking into account a state time for which the one or more base stations have been in a present transmission state. The transition points therefore have a temporal element, which effectively sets a minimum time period between transitions, though the state time required to satisfy the threshold mechanism may be different for a low to high transition than for a high to low transition. This may be one of more than one transmission performance values that define the transition point. Setting a transition point taking into account a particular factor, parameter, or transmission performance value, may mean either that that factor, parameter, or transmission performance value is used in a calculation performed in order to set either or both of the transition points, or may mean that either or both of the transition points include an acceptable value or range of that factor, parameter, or transmission performance value at which the threshold mechanism is satisfied. The state time may be a minimum duration between the most recent transition into a particular state, and a transition out of that state, and may be different for each transmission state.

In preferable embodiments, the threshold mechanism includes an additional constraint to be imposed by the transmission state management unit, so that the transition points are set taking into account whether a condition related to the value representing current data load over a period of time is met. Advantageously, the provision of an additional condition with a temporal dependence can be used to further improve the stability of the system, and ensure that the transmission state of the one or more base stations is not changed unnecessarily. An example of such a condition could be that the value representing current data load is at a level satisfying the threshold mechanism for a continuous period of n seconds, or that the current data load is at a level satisfying the threshold mechanism for a certain proportion of a given time period of n seconds. A required level of the value representing current data load, a time period of n seconds, and the proportion where appropriate, may thus be considered to constitute the transition point or points.

The specific choice of condition may depend not only on the quality of service (QoS) requirements of the network operator, but also on the data load measurement process of the one or more base stations. For example, it may be that the measurement process does not strictly reflect a different time period each time, for example when the value representing current data load is calculated by taking a highest measurement of a series of measurements related to the one or more base stations, each measurement representing an amount of user data to be transmitted in a particular time sample. In such a process, regardless of the time at which the highest measurement was taken, the value representing current data load is still considered to be valid, for example, at the time of the latest of the series of measurements (though the relevant measurement could have been taken, for example, at a mid-point in the series in time).

Alternatively, the condition may be termed a ‘time to trigger’, simply a duration of time for which the level of the value representing current data load must be at a sufficient level in order to satisfy the threshold mechanism.

In embodiments in which the value representing current data load is measured at discrete time samples, it is preferable that the condition is met when a defined proportion of a defined number of consecutive values representing current data load is at a particular level. The level and the number of consecutive values thus define the transition point. Therefore, if the value representing current data load is at a level sufficient to satisfy the threshold mechanism for, for example, 4 out of the last 5 samples, then the threshold mechanism is satisfied. The values of the defined number, time interval between samples and the proportion of samples out of that number required to be of a certain value in order to satisfy the threshold can be set by the network operator based on quality of service requirements in the network, and may be adaptable, either manually or based on some algorithm.

As a further parameter which can be used to control the tendency of the base station or group of base stations to be in certain transmission states or to transition between states, beyond the dependency of the transition point on a current state and the time-related condition, in preferable embodiments the value representing current data load incorporates an adjustment, the adjustment being a shift in the magnitude of the value representing current data load prior to application of the threshold mechanism. This adjustment may be referred to as a margin, negative margin, or safety margin, depending on the implementation. Furthermore, the margin may be adaptable either manually or automatically depending on network environment.

If the network operator wishes to reduce the risk of being under-resourced, embodiments of the present invention may incorporate the application of a safety margin to measurements of current data load or to the value representing current data load. The addition of a small margin to the value representing current data load will give the base station or group of base stations a tendency to be in a higher transmission state than the data load requires.

Alternatively, the network operator may be particularly conscious of superfluous power consumption and operational expenditure, and at various times, for example, at night time, may want to incorporate the application of a negative margin to measurements of current data load or to the value representing current data load. The subtraction of a small margin to the value representing current data load will give the base station or group of base stations a tendency to be in a lower transmission state than the data traffic requires.

The transmission states between which the threshold mechanism is used to control changes may be the two-states of only two possible states, a higher state having an upper capacity limit (or simply capacity) equal to the maximum capacity of the base station or group of embodiments, and a lower state having a lower upper capacity limit (or simply capacity). In such a two-state embodiment, the level at which the threshold mechanism is satisfied, regardless of a present transmission state, will be at around the capacity of the lower state, but the level for changing from a lower to a higher state will be higher than the level for switching from a higher to a lower state. This idea extends to multiple-state embodiments, in which the one or more base stations are operable to transmit in one of three or more transmission states. It may be that the two transmission states between which switching occurs are two neighbouring states in a multiple-state system are neighbouring states when placed in order of capacity. Alternatively, the switch may be between, for example, a first and a third state. Optionally, the first and second transmission states are any two of more than two transmission states, each of the more than two transmission states having an associated upper capacity limit.

It has been alluded to in the above discussion that the parameters of the threshold mechanism included in the transition points may be adaptable, either manually or automatically according to an algorithm including some dependency on the current network environment. It may be as simple as changing transition points depending on the time of day, so that, for example, the one or more base stations have a reduced tendency to enter a higher transmission state at night, hence time of day would be a factor of the current network environment. Adaptation of the transition points of the threshold mechanism is advantageous since it gives more control to the network operator, and offers the flexibility to use embodiments of the present invention to react to changing network and quality of service requirements. Preferably, the controller includes a threshold mechanism adaptation unit operable to adapt one or more of the following parameters:
the transition point value for the value representing current data load at which the threshold mechanism is satisfied;
the transition point time- or trend-based condition having some temporal dependency;
the transition point value representing the minimum duration for which the one or more base stations have been in their present transmission state (dependent upon the present transmission state) prior to permitting a transition;
the adjustment (polarity or size) to the value representing current data load.

As well as being operable to change the values of these transition point and other parameters, the adaptation unit may also be operable to turn the parameters off (in which case they no longer influence the threshold mechanism) and on. The adaptation unit may be operable to change any value or parameter of the threshold mechanism.

The adaptation unit may carry out adaptation based on various factors, such as a fraction or amount of current data load having a particular quality of service requirement, such as a minimum guaranteed bit rate.

Further aspects of the invention are provided in the form of a server including the controller as described herein, the server being suitable for use in a wireless telecommunications system and a base station including the controller as described herein, and suitable for use in a wireless telecommunications system.

According to one method aspect there is provided a method for use in a controller of a wireless telecommunications system, the telecommunications system including one or more base stations, the one or more base stations being operable to wirelessly transmit data to user equipments in a first transmission state having a first capacity and in a second transmission state having a second, higher, capacity, the one or more base stations also being operable to change between transmission states in response to a transmission state change instruction from the controller, the method comprising applying a threshold mechanism to a value representing current data load, and if the threshold mechanism is satisfied, issuing a transmission state change instruction to change between the two transmission states, wherein, a transition point of the threshold mechanism for a transition from the first to the second transmission state is set independently from a transition point for a transition from the second to the first transmission state.

According to a further method aspect carried out in the controller there is provided a method for use in a wireless telecommunications system, the telecommunications system including one or more base stations, wherein the one or more base stations wirelessly transmit data to user equipments in a first transmission state having a first capacity or in a second transmission state having a second, higher, capacity, and the controller applies a threshold mechanism to a value representing current data load, and if the threshold mechanism is satisfied, issues a transmission state change instruction to change between the two transmission states, wherein, a transition point of the threshold mechanism for a transition from the first to the second transmission state is set independently from a transition point for a transition from the second to the first transmission state.
Finally, in a computer program aspect, there is provided a computer program, which, when executed by a computing device, causes the computing device to become the controller as described herein or to execute a method as described herein.
In any of the above aspects, the various features may be implemented in hardware, or as software modules running on one or more processors.

The computer program may be provided in the form of a computer program product, such as a computer readable medium having stored thereon a program for carrying out any of the methods described herein. A computer program embodying the invention may be stored on a computer-readable medium, or it could, for example, be in the form of a signal such as a downloadable data signal provided from an Internet website, or it could be in any other form.

Features and preferable features of any aspect of the invention may be applied to each other aspect of the invention.

Embodiments of the present invention are operable to define transition points of a threshold mechanism and to perform a process for assessing when to instruct a transition in transmission states to enable operation of an energy efficient telecommunications network. To enable a more stable and reliable operation of a base station or group of base stations, and of a network overall, embodiments of the present invention are operable to apply to values representing the current data load a threshold mechanism which is satisfied at one of two independently set transition points, which of the two transition points being dependent upon the present transmission state of the system. The transition points may each incorporate more than one parameter so that a transition point is not necessarily merely a value or range of values representing current data load at which the threshold mechanism is satisfied. A further condition, such as a time to trigger may be included in the transition points, or a margin or safety margin may be incorporated into calculations of the value representing current data load. Furthermore, in certain embodiments, the transition point can adapt depending upon the actual data load conditions and system configuration.

Advantageously, the threshold mechanism of embodiments of the present invention is designed so as to offer operational flexibility. For example, to provide a higher level of energy saving at the cost of some degradation in throughput performance, or a lower level of energy saving by ensuring a guaranteed bit rate to the users. For an operator, this would become a trade-off between OPEX reduction achieved from energy reduction, against revenue lost due to service degradation to the user. Optionally, transition points of the threshold mechanism and other parameters are scalable as per the operator's KPI (Key Performance Indicator) requirements.

Preferred features of the present invention will now be described, purely by way of example, with reference to the accompanying drawings, in which:—

FIG. 1 is an exemplary graph of user data load against time demonstrating changes between high demand and low demand with reference to a ‘low capacity’ of a lower transmission state;

FIG. 2 is an illustrative example of two transmission states of groups of base stations, exemplifying transmission states in embodiments of the present invention;

FIG. 3 is an illustrative example of two transmission states of individual base stations, exemplifying transmission states in embodiments of the present invention;

FIG. 4 is an exemplary graph of user data load against time, showing transitions between transmission states and the associated capacities;

FIG. 5 is an exemplary graph illustrating the Ping-Pong effect' in which small variations in data load at or around the level of the capacity of a lower transmission state give rise to frequent switching between two transmission states;

FIG. 6 is an exemplary graph illustrating the ‘False Trigger’ effect, in which a small peak in data load gives rise to an unnecessary change from a lower to higher transmission state;

FIG. 7 illustrates a reverse ‘False Trigger’, in which a small dip in data load gives rise to an unnecessary change from a higher to a lower transmission state;

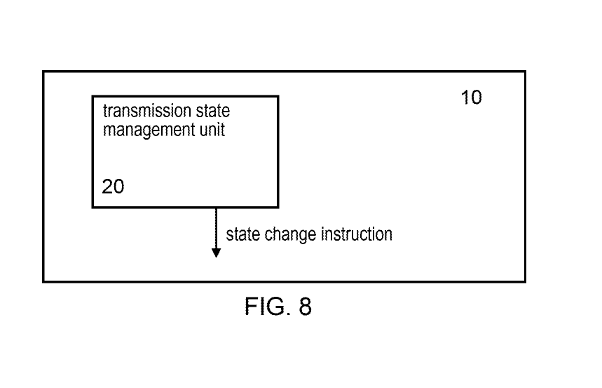

FIG. 8 is a schematic diagram of a controller according to invention embodiments;

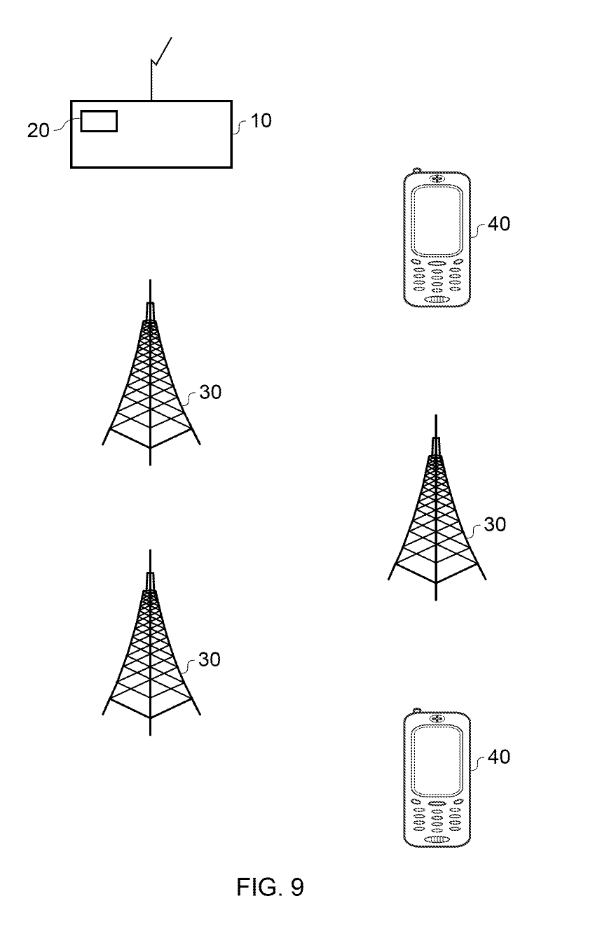

FIG. 9 is a schematic diagram of a wireless network according to invention embodiments;

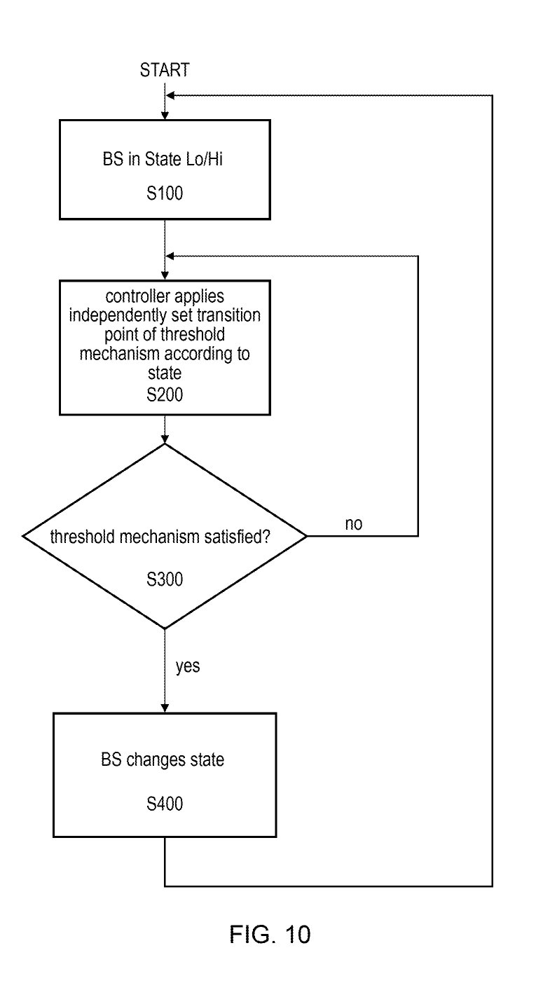

FIG. 10 is a flow chart demonstrating a general method embodiment of the invention;

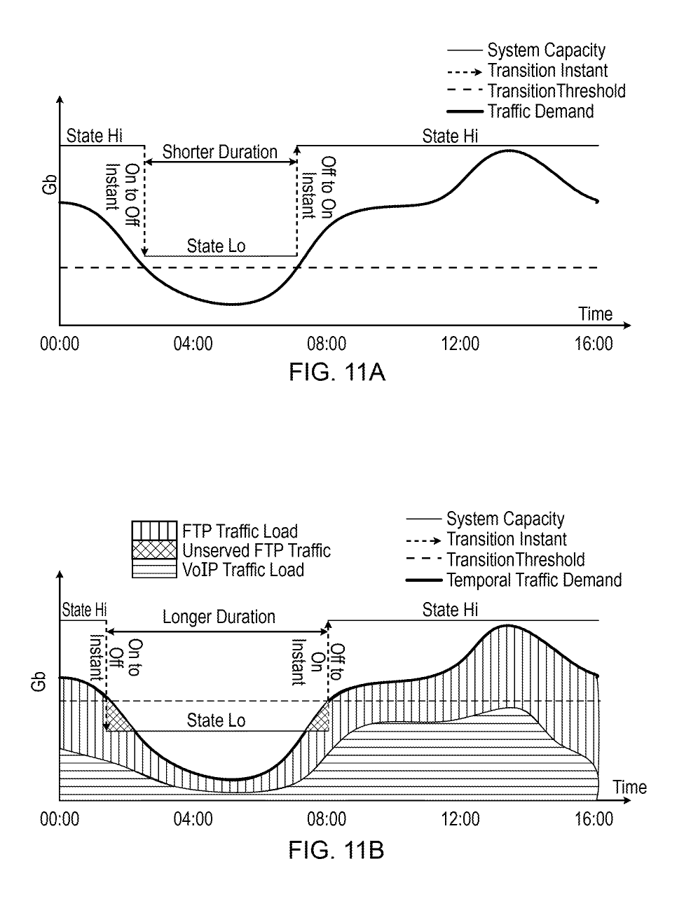

FIG. 11a is a graph of traffic against time and demonstrates a situation in which a transition between states may occur at a value of traffic below the capacity of the lower transmission state;

FIG. 11b is a graph of traffic against time and demonstrates a situation in which a transition between states may occur at a value of traffic above the capacity of the lower transmission state when the QoS requirements of the data load is considered;

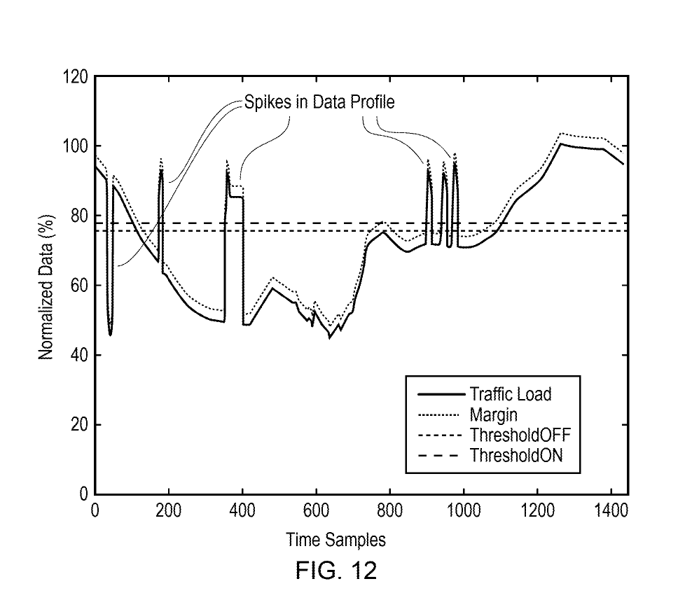

FIG. 12 is a graph of a MATLAB simulation showing separate levels for switching between Hi and Lo states;

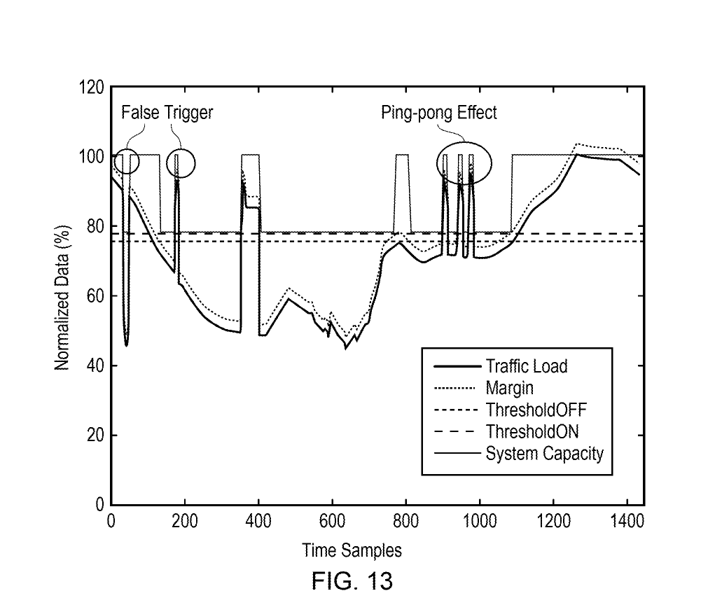

FIG. 13 is a graph of a MATLAB simulation showing the same simulation data with the state switch shown;

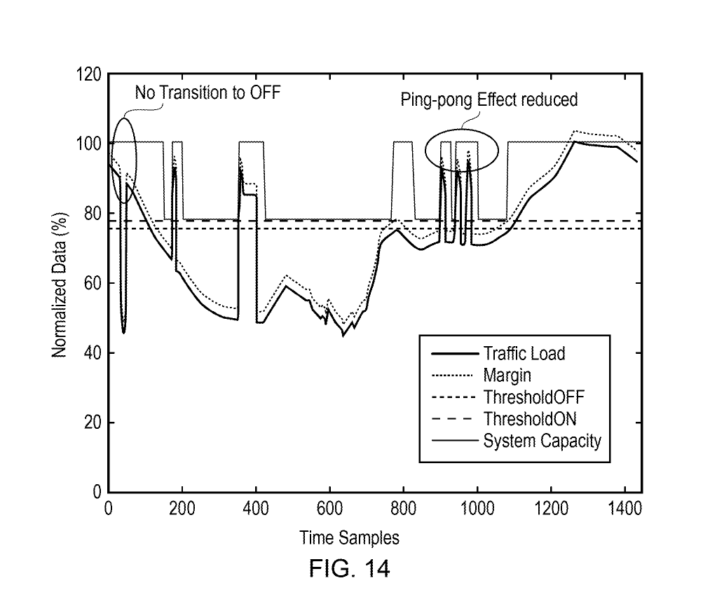

FIG. 14 is a graph of the same MATLAB simulation with a time to trigger parameter set for switching from the Hi to the Lo state;

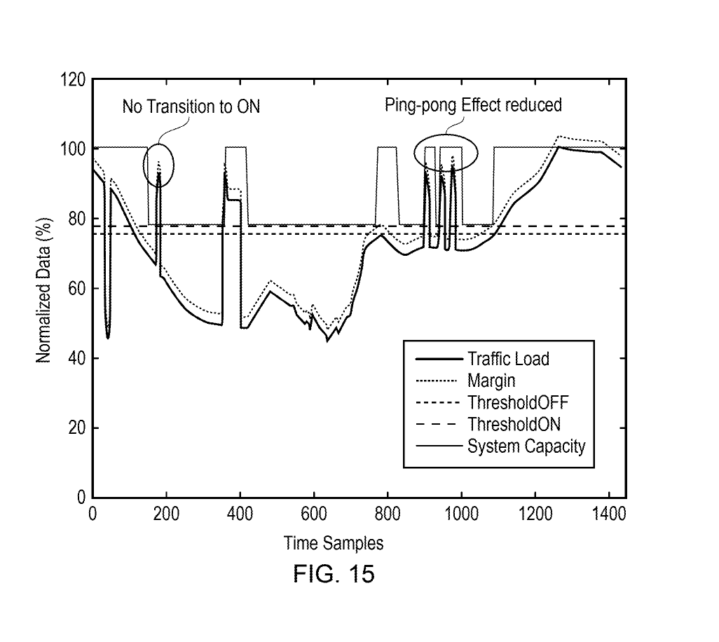

FIG. 15 is a graph of the same MATLAB simulation with a time to trigger parameter set for switching from the Lo to the Hi state;

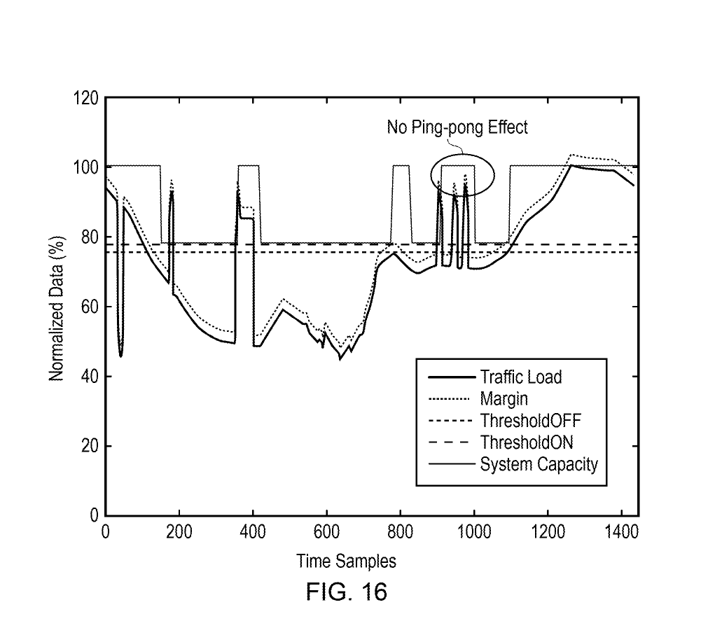

FIG. 16 is a graph of the same MATLAB simulation with a higher time to trigger parameter set for switching from the Hi to the Lo state than in FIG. 15; and

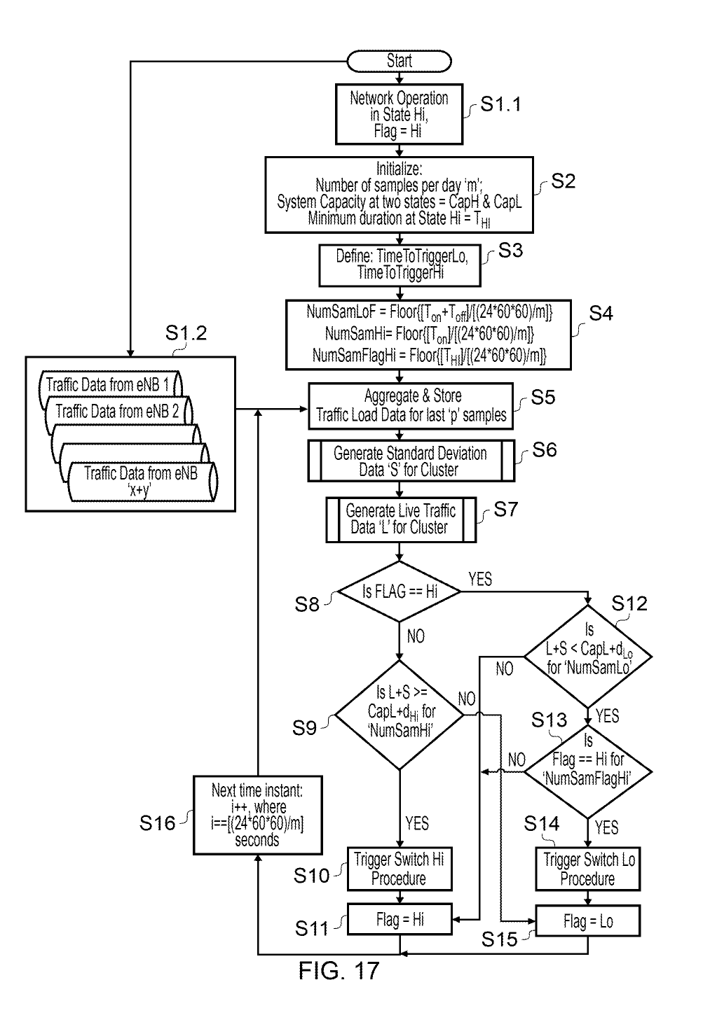

FIG. 17 is a flow chart demonstrating a threshold mechanism according to a specific invention embodiment.

FIG. 8 shows a simplified view of a controller 10, with a transmission state manager 20 applying a threshold mechanism according to invention embodiments in which the transition points of the threshold mechanism for a transition from a lower to a higher transmission state and from a higher to a lower transmission state are set independently, and which can also incorporate a margin or safety margin in to a value representing current data load. Furthermore, in certain embodiments, these parameters can adapt depending upon the actual data load conditions and system configuration. The manager issues a state change instruction when the mechanism is satisfied.

The controller and/or transmission state manager may include processing capability and memory. The controller may further comprise a transmitter (not shown) if it is also responsible for transmitting the instruction to one or more eNBs.

FIG. 9 shows a schematic view of a wireless network, here with three base stations 30 (although a single base station may carry out the method), two UEs 40 and a controller 10, with its manager 20. The controller is shown as a separate network entity from the base stations, but may be incorporated in one or more of the base stations.

FIG. 10 shows a general flow chart for a simple method embodiment, carried out by the controller. In S100 a base station is in one of two states, “Lo” or “Hi”. In step S200 the controller applies the threshold mechanism. In step S300 it is determined whether the threshold mechanism is satisfied, if so base station state changes in step S400. If not the method is repeated.

The threshold mechanism transition points are those that determine the transition instant for the High→Low or Low→High state of a system (for example one or more base stations) in an Energy Efficient Network. Some possible differences in transmission parameters between a base station or group of base stations are outlined in cases (i) to (v) above, and these are all possible distinctions between higher and lower transmission states in embodiments. The transition point for a low to high transition is set independently to that for a low to high transition. For example, the transition point value representing a current data load at which the threshold mechanism is satisfied may be different for High→Low & Low→High transitions. This may desirable, for example, in a case in which the operator wants to define more a more cautious transition point for High→Low transitions compared to that for Low→High transitions.

The threshold mechanism of embodiments uses twin transition points at which the threshold mechanism can be satisfied for a two state system, one for High→Low transition and another for Low→High transition. For a multi state system, the threshold mechanism of embodiments can apply multiple transition points at which the threshold mechanism can be satisfied: number of values=2*[number of states−1]. For stability, in embodiments in which the transition points each define a different level of current data load at which the threshold mechanism can be satisfied for any pair of transmission states, the transmission state management unit may apply the constraint that the level at which the threshold mechanism is satisfied for a High Low transition is less than (or less than or equal to) that for a Low High threshold transition. This introduces hysteresis in the threshold mechanism which can reduce the ping-pong between the two states exemplified in the graph of FIG. 5. The larger the difference between the two levels, the greater the ability to reduce the ping-pong between the two states. In addition, the transition points can include further conditions such as Time_to_Trigger_Hi and Time_to_trigger_Lo, which are continuous time periods for which the value representing current data load must be at a level sufficient to satisfy the threshold mechanism (that level being dependent upon the present transmission state of the one or more base stations) to further improve the robustness, stability and flexibility of the threshold mechanism.

As mentioned previously, the ‘system’ to be considered for transition may be an individual base station (for example when number of sectors/bandwidth per site is reduced) such as a base station 1c in FIG. 3, or a cluster of base stations (for example when base stations are switched off), such as those clusters illustrated in FIG. 2 in which base stations 1a remained switched on in both states, and base stations 1b are switched off in the low state. An example will now be provided of how the value representing current data traffic (can also be considered ‘current data traffic load’) of the system is derived for the purpose of the threshold mechanism.

### (a) Current Data Traffic for an Individual Base Station

Assume that last a series of ‘p’ samples (measurements) of traffic loading for the base-station is represented by lⱼ where j=(1 to p). Then the ‘current’ traffic load for the base-station is defined as:

L=max(l₁,l₂,l₃ . . . ,lₚ)=max lⱼ

wherein ‘max’ is a function returning the highest numerical value of a series of values.

### (b) Current Data Traffic for a Cluster of Base Stations

Assume that last ‘p’ samples of traffic loading for ‘x+y’ sites in the cluster are represented by lⱼₖ where j=(1 to p) & k=(1 to ‘x+y’). Then the ‘current’ traffic load data for the cluster is defined as:

L=max [sum(l₁₁,l₁₂, . . . ,l_{1(x+y)}),sum(l₂₁,l₂₂, . . . ,l_{2(x+y)}), . . . ,sum(lₚ₁,lₚ₂, . . . ,l_{p(x+y)})]

If the sample interval is ‘i’, then ‘lⱼ’ or ‘lⱼₖ’ is averaged over the period ‘i’. It is also possible to use weighted averaging here.

The value of ‘p’ is more than or equal to one and is typically few samples. The parameter ‘p’ is the sliding-window for smoothing the effect of short-term variation of traffic loading in time. The smaller the value of p greater the short term variation in the filtered output.

Thus, the ‘live’ traffic load measurement process is chosen to be quasi-instantaneous and the use of the maximum (highest) value function ensures that the worst case scenario of traffic demand is considered when applying the threshold mechanism. The sliding window for filtering the data aids in minimizing the probability of “false-trigger” (see FIGS. 6 and 7) & “ping-pong effect” (see FIG. 5). The “Max” value over the sliding-window aids in minimizing the probability of “late” Low→High transitions.

Alternatively, other methods for calculating a value representing the current data traffic (which may be the load of data traffic, but could be extended to other metrics) can be employed. For example, a mean or median value from p samples, or a maximum value excluding outliers beyond a certain number of standard deviations from the mean or median.

For transition from State Low with system capacity of CapL to State High with system capacity of CapH, the following transition point value for current data load is set and/or applied:

Switch-Hi Value=CapL+d_{Hi}

The chosen value of ‘d_{Hi}’ provides a trade-off between the QoS and Energy Saving, and in certain embodiments is adaptable, and can be positive or negative.

In the case of a system where State High and Low involve a different number of base stations (for example, FIG. 2), the value of CapL is measured independently for each cell within the system at State Low. It may be, for example, that the Switch-Hi Value must be crossed by at least one base station (in State Low) to trigger the transition.

For transition from State Hi with system capacity of CapH to State Lo with system capacity of CapL, we define the following transition point value for current data load:

Switch-Lo Value=CapL+d_{Lo}
where the management unit may apply the additional constraint that d_{Lo} is less than d_{Hi}.

In the case of a system where State High and Low involve a different number of base stations, the value of CapL may be derived by aggregating traffic load for all cells in each sub-cluster where a sub-cluster in State High corresponds to each cell in State Low, because in certain embodiments fewer base stations are transmitting when the system is in State High than when it is in State Low. Optionally, the Switch-Lo Value must be crossed by all sub-clusters (in State High) to trigger the transition to State Low. This approach enables the trigger mechanism to operate in real-life network in which the cell sizes, cell capacities, traffic loading levels of adjacent cells are non-uniform/unequal. Alternatively, each sub-cluster may have its own controller, so that one sub cluster does not need to consider other sub-clusters. Of course, a single base station may be a member of more than one sub-cluster, and in embodiments such as these it is preferable that if any of the sub-clusters of which the base station is a member are in State High, that the base station is turned on. The transition point values for current data load are expressed above as absolute values or rates, however, it is preferable to utilise normalised traffic load values and normalised cell capacity values, particularly where adjacent cells are unequal. A lack of equality between neighbouring cells could be, for example, due to design differences between the two cells, or due to different geographic coverage requirements in use. This normalisation may be with respect to the maximum capacity a base station (cell) can offer. For the “down transition” as well as the “up transition” the normalisation should preferably be with respect to the CapL. In such real-life deployment situations, the threshold mechanism of invention embodiments offers full flexibility by allowing a level of a value representing current data load at which the threshold mechanism is satisfied at each cell to be different to enable better balancing of energy saving and grade of service of non-GBR (guaranteed bit rate) traffic.

To reduce the rapid ping-pong switching between two transmission states, an effect illustrated in FIG. 5, it may be that the management unit setting the transition points applies the constraint that the Switch-Lo Value is required to be lower than the Switch-Hi Value. The value of d_{H}, as well as d_{Lo} may be positive, i.e., the thresholds may be defined higher than the value of ‘CapL’. However, this may potentially lead to packet loss due to not having sufficient network capacity to support the traffic demand, for example, if the value of dₗₒ was positive then the system could switch to State Low with upper capacity limit CapL, but traffic load could be higher than CapL.

Modern networks carry mixed QoS traffic, some with a guaranteed minimum bit rate such as VoIP, and some without minimum GBR, such as FTP, and as long as the available capacity is sufficient to serve the traffic having a minimum guaranteed bit rate and SLA (Service Level Agreement) constrained traffic and some of the non-minimum guaranteed bit rate/SLA constrained traffic, this may not be critical.

SLA constrained traffic implies that the operator is bound to meet certain coverage and capacity criteria. Additionally, it implies that clauses within an SLA may preclude the operator from exceeding certain capacity values irrespective of the demand. For example, the SLA may define that the operator will meet user throughput of no more than 10 Mbps. In such a case, even if there is a higher demand for data, the operator need not meet it as long as a throughput value of 10 Mbps per user is being met. Likewise, the SLA may also include restrictions on certain traffic types rather than all traffic, for example, FTP is ‘best-effort’ while VoIP is guaranteed a certain bit-rate and limited latency.

As an example, there may be two classes of QoS being offered for two different traffic types respectively. Assume that these two classes are Guaranteed-Bit-Rate (GBR) for traffic type ‘Voice over IP’ or ‘VoIP’ and non-Guaranteed-Bit-Rate (nonGBR) for traffic type ‘FTP’ or ‘File Transfer Protocol’. In such a case, the Switch-Lo Value may be allowed to operate higher than the value of ‘CapL’ so that QoS is still being met for the VoIP traffic as well as FTP traffic within the respective QoS criteria.

By adjusting the Switch-Lo Value and the Switch-Hi value based on QoS class of traffic, for example, by increasing the Switch-Hi value to be above CapL by an amount not more than the amount of nonGBR traffic, a greater gain in energy efficiency may be achieved. This is illustrated in FIG. 8b where the system operates for a longer duration in ‘State Lo’ compared to that in FIG. 8a. For simplicity in demonstrating the effect of adapting the values at which a system switches from State Low to State High and vice-versa according to QoS requirements of traffic in the traffic load, the value representing current data load at which the threshold mechanism is satisfied is drawn the same regardless of a present transition state in FIGS. 8a and 8b. The significant point in FIGS. 8a and 8b is that in FIG. 8b, by considering the QoS requirements of the data, the value of data load at which state transitions occur is higher than in FIG. 8a, where QoS requirements are not considered. Thus, the system in FIG. 8b is able to operate in the State Low for a longer duration, and energy is saved.

FIG. 11a illustrates current data load against time. The value of traffic level at which a transition between states will occur is below the value of CapL, the capacity of the transmission State Low. Therefore, the data traffic load should never exceed the capacity of the transmission state, and packet loss is minimised and packet delivery is prompt.

FIG. 11b illustrates current data load against time, and also distinguishes between two types of data traffic: VoIP having a minimum GBR, and FTP not having a minimum GBR. The transition point value of current data load at which transitions between transition states will occur is above the capacity of the transmission State Low. Therefore, there are periods of time in which a quantity of FTP traffic remains unserved and thus its delivery is delayed. However, the data traffic load of VoIP data having a minimum GBR is always below the capacity of the transmission state, and hence there should be little or no loss or delay of VoIP traffic.

Next, an optional additional feature is discussed in which the transition points are set including an additional condition with a temporal basis. The example detailed is a simple one in which the additional condition is simply a continuous period of time (TimeToTrigger) for which the value representing current data load must be at a level sufficient to satisfy the threshold mechanism (the transition point value for current data load), that level being dependent on a present transmission state of the system.

When the system is in transmission state low and the value representing current data traffic reaches a level at which the threshold mechanism can be satisfied for a Low→High transmission state transition, then a timer trigger is kicked off for the transition procedure. Only if the value representing current data load remains at a level at which the threshold mechanism can be satisfied for the time defined for Time To Trigger Hi will an instruction be issued to initiate state transition to the higher state. The value of Time to trigger Hi is denoted by: “TimeToTriggerHi”. The system will be able to serve traffic in the State Hi only after a duration of:

TimeToTriggerHi+Tₒₙ

after data load first reaches a level which will satisfy the threshold mechanism, where ‘Tₒₙ’ is the transition time for the system to change the state from Low→High. So, even if a transmission state change instruction is issued by a base station controller after the threshold mechanism is satisfied, it will still take a time Tₒₙ for the transition to take effect.

The value for TimeToTriggerHi may be set to ‘0’ in order that when the traffic loading increases, the system is always forced to transition to Hi state. This may be desirable if QoE (quality of experience) or Throughput is the key performance indicator (KPI). Thus, the value of this threshold mechanism parameter is also dependent on the network performance requirements and is adaptable. QoE is defined from a user perspective, in contrast to QoS, which is defined from an operator perspective. There is a minor difference between the two measures since in order to ensure a certain level of QoE, more stringent values may be applied to QoS parameters.

When the system is in transmission state high and the value representing current data load reaches a level at which the threshold mechanism can be satisfied for a High→Low transition, then a timer trigger is kicked off for the transition procedure. Only if the value representing current data load remains at a level at which the threshold mechanism can be satisfied for the time defined by Time To Trigger Lo will an instruction be issued to initiate a state transition to the lower state. The value of Time to trigger Lo is denoted by “TimeToTriggerLo”. The system will be able to serve traffic in the State Lo only after a duration of:

TimeToTriggerLo+T_{off}

after data load first reaches a level which will satisfy the threshold mechanism, where ‘T_{off}’ is the transition time for the system to change the state from Hi→Lo.

An optional additional check may be carried out before the transition from State High to State Low. This involves checking the condition whether the system has remained in State Hi for a minimum period of “T_{HI}” time (regardless of the level of the value representing data load during that time). The trigger for Hi→Lo transition is kicked off only if this additional condition is true. This additional check merely provides an additional stabilising effect.

The minimum resolvable duration of an Low→High→Low or High→Low→High cycle is function of the sum of all the times as follows:

Tₒₙ+T_{off}+TimeToTriggerHi+TimeToTriggerLo+T_{HI}

The above should be taken into account while setting the values for Time to Trigger Hi/Lo transition point values, and it may be that a minimum value for the minimum resolvable duration is set.

The ‘TimeToTriggerLo’ & ‘TimeToTriggerHi’ threshold mechanism parameters minimize the probability of “False Trigger” (see FIGS. 6 and 7). Also, the ‘TimeToTriggerLo’, ‘TimeToTriggerHi’, ‘T_{HI}’ and systems (a) and (b) for calculating the value representing current data load minimize the probability of “Ping pong effect” (see FIG. 5).

Optionally, one or more of the transition point values and the nature of the transition points can be set and adapted based on any combination of the following:
standard deviation or variance of traffic loading measurements (or the standard deviation or variance of the value representing current data traffic);
total traffic load;
the tolerable compression of capacity of non-QoS/SLA constrained traffic, that is to say, FTP and other forms of traffic have a non-guaranteed minimum but rate provide a form of traffic which does not need to be served immediately and hence the total traffic load can exceed capacity of the present transmission state as long as the amount of traffic having minimum GBR does not exceed capacity of the present transmission state.

The adaptation can be either continuous 24 hrs a day 7 days a week or activated when the traffic loads are approaching the state transition (eg: within a pre-specified traffic conditions).

Care must be taken not to destabilize the system. The speed and amount of adaptation should be carefully controlled to maximise the energy efficiency, minimise the ping-pong state switching and ensure not to adversely degrade system performance. The Switch-Hi Value and Switch-Lo Value can be independently set and adapted but ensuring that the following condition is observed: Switch Hi Value>Switch Lo Value.

Furthermore, transition point values may be adapted based on a rate of change of the value representing current data load (or of some other measure of current data traffic) with respect to time. In this way, a time to trigger (high or low) can be reduced if the current data load is rising or falling at a rate which indicates a sustained change in data load is occurring. For example, a very rapid rate of change of data load with respect to time may indicate a spike (or sudden dip) in data load for which the time to trigger transition point values should remain at a value sufficient to counter such spikes. However, if the rate of change of data load with respect to time indicates a steady rise or fall of data load, then the time to trigger parameters may be set to zero. In other words, the time to trigger parameters can be adaptively introduced as safety measures when the magnitude of the rate of change of data load with respect to time is above a predetermined value.

Optionally, a safety margin can be applied to the value representing current data load prior to application of the threshold mechanism. The margin can be prefixed as a absolute value or as a proportion of the traffic load. Alternatively the margin can be a function of standard deviation “S” or variance of the short term variation of the traffic loading. The margin provides a safeguard of providing adequate capacity “head-room” in the network in the “State-Low”.

A simulation was carried out in Matlab to study the impact of ‘spike’ features in the traffic load on the state transition process and how the ‘Time To Trigger’ conditions help in minimizing the undesirable adverse state transitions due to these features.

In each of FIGS. 12-16, the Y-axis depicts the traffic or data load value normalized with respect to the peak capacity of the system in the higher transmission state. Thus, the system peak capacity is 100% in the higher transmission state and all other values are scaled in accordance. The X-axis depicts the traffic loading for a 24 hour duration in which data samples are available for 5 minute discrete intervals leading to 1440 samples.

FIG. 12 shows a Traffic Data Profile at discrete time sampling instants. A sample profile was created with value of ‘C’ (current data load) defined at discrete time intervals (Time samples) plotted as Traffic Load on FIG. 12. The profile contains spike-like features in the data that deviate from the regular trend.

The parameters ‘Switch Lo Threshold’ & ‘Switch Hi Threshold’ are marked in ‘dashed’ and ‘dashed-dotted’ lines respectively. The ‘dotted’ curve depicts the parameter ‘margin’ above the Traffic Load profile.

If the “Time To Trigger” parameter values are set to zero, then the system state changes from Hi to Lo or vice-versa as shown by the ‘solid’ thinner plot in FIG. 13 (Time to Trigger (Hi or Lo) and T_{HI} set to 0). Note the ‘false trigger’ and the ‘ping-pong effect’ in the state transition due to the ‘spike’ features in the data.

As the next step, the value of “TimeToTriggerLo” was set to a positive value of 4 samples. The result is shown in FIG. 14 (TimeToTrigLo set to positive value) and it is seen that the “false-trigger” to state Lo is eliminated. Also, the ping-pong effect is reduced to some extent.

Further, the value of “TimeToTriggerHi” was set to a positive value of 2 samples. The result is shown in FIG. 15 (TimeToTrigHi set to positive value where TimeToTrigHi<TimeToTrigLo). It is seen that the “false-trigger” to state Hi is eliminated and the ping-pong effect is reduced to some extent.

T_{HI} represents the minimum time for which the state should remain in Hi irrespective of whether the threshold mechanism has been satisfied for a transition from high to low. For example, the transition from low to high may happen at time instant t0; then the trigger condition is met for further transition from high to low a time instant t1, where |t1-t0|<T_{HI}. In such a case, the transition should be deferred until expiry of Tₓ', which is reset for every transition from low to high. Likewise, the parameter T_{LO} may be defined which mandates the system to remain in state Lo for a duration of T_{LO} after transition from high to low irrespective of the threshold mechanism.

As a final step, the value of “T_{HI}” was set to a positive value of 6 samples. The result is shown in FIG. 16 (T_{HI} set to a positive value) and it is seen the ping-pong effect is totally eliminated in this example.

The Trigger Mechanism defines the flow of events to determine the trigger instant of a cluster for transition from Hi→Lo or Lo→Hi based on the Trigger Parameters defined in the previous sections. FIG. 17 is a flowchart demonstrating a process by which a base station (enhanced Node Basestation or eNB) controller can decide whether to initiate a change of transmission state.

Step S1.1 is an initialisation step in which the controller accesses information indicating the current transmission state of the system (High), and sets a flag to Hi accordingly. Alongside this initialisation step is a data gathering step S1.2 in which traffic load measurements are received from each of the x+y eNBs in the cluster of base stations whose transmission state is controlled by the controller. Step S1.2 is a continuous step by which live traffic load measurements are streamed during network operation via some reporting method.

A further initialisation step S2 sets the known parameters for the system, these may be accessed from a memory. The known parameters include: the number of samples of traffic data measurements per day, the amount of time required to transition between states low and high (‘Tₒₙ’) and between states high and low (‘T_{off}’) once an instruction has issued, system capacity for the higher capacity state ‘CapH’ and system capacity for the lower capacity state ‘CapL’, and a minimum duration for the system to remain in the higher capacity state ‘T_{HI}’.

In step S3 the values of variables ‘TimeToTriggerHi’ and ‘TimeToTriggerLo’ in seconds are set. These values are adaptive and can be changed.

In step S4 a calculation is carried out to define the number of samples of the value representing current data load which must be at a level sufficient to satisfy the threshold mechanism as follows:

### Define Number of Samples to Trigger Hi or Lo:

NumSamLo=floor {[TimeToTriggerLo]/[20*60*60/m]};

NumSamHi=floor {[TimeToTriggerHi]/[20*60*60/m]};

NumSamFlagHi={[T_{HI}]/[20*60*60/m]}.

Where NumSamLo is the integer number of samples which must be at a certain level to initiate a State High to State Low transition, NumSamHi is the integer number of samples which must be at a certain level to initiate a State Low to State High transition, and NumSamFlagHi is the integer minimum number of samples for which the system must be in state High before permitting a transition to State Low.

At step S5 the controller aggregates and stores the traffic load measurements from one or more sites (base stations) for the last ‘p’ samples based on data available from Step 1.2.

At step S6 the controller generates the standard deviation value ‘S’ for the system. In this exemplary embodiment, the value S is used as a safety margin or adjustment, and is added to the value representing current data load prior to application of the threshold mechanism.

At step S7, the controller is operable to generate live data value 1′ for the one or more base stations in the cluster it controls. This live data value L is an example of a value representing current data load and potential processes by which it may be derived are described above.

At step S8 a check is performed of the state flag. The state flag is set to ‘Hi’ if the present transmission state of the system is High, and to ‘Lo’ if the present transmission state of the system is Low. If the flag is set to Hi, the flow proceeds to step S12. If, on the other hand, the flag is not set to ‘Hi’, the flow proceeds to step S9.

At step S9 the controller checks whether the expression “L+S>=CapL+d_{Hi}”, where CapL+d_{H}, is the transition point current data load value or the level of the value representing current data load (including safety margin adjustment) at which the threshold mechanism is satisfied, has been true for the “NumSamHi” most recent samples. If it has, then the flow proceed to step S10 in which the transition to State High is initiated. This maybe via the issuance of a transmission state change instruction. The flow then proceeds to step S11 at which the flag is set to ‘Hi’, and on to step S16. If the check in step S9 is not satisfied, the flow proceeds to step S15 where the flag is set to ‘Lo’, and the flow proceeds to step S16.

At step S12 the controller checks whether the expression “L+S<CapL+d_{Lo}”, where CapL+d_{Lo} is the level of the value representing current data load (including safety margin adjustment) at which the threshold mechanism is satisfied, has been true for the “NumSamLo” most recent samples. If it has, then flow proceeds to step S13. If it has not, then the flow proceeds to step S11, at which the flag is set to ‘Hi’ and the flow proceeds to step S16.

At step S13 the controller performs an additional check to verify that the state has been in the transmission state High for the number of samples representing the minimum duration for which the system can remain in the higher state. If it has not, then the flow proceeds to step S11, and the flag is set to ‘Hi’ and the flow proceeds to step S16. If it has, then the flow proceeds to step S14 in which the transition to state Low is initiated. This may be via the issuance of a transition state change instruction.

At step S16, the system prepares for the threshold mechanism to be applied at the next time sample, and the flow returns to step S5.

1. A controller for use in a wireless telecommunications system, the telecommunications system including one or more base stations, the one or more base stations being operable to wirelessly transmit data to user equipments in a first transmission state having a first capacity and in a second transmission state having a second, higher, capacity, the one or more base stations also being operable to change between transmission states in response to a transmission state change instruction from the controller;
the controller comprising:
a transmission state management unit operable to apply a threshold mechanism to a value representing current data load, and if the threshold mechanism is satisfied, to issue a transmission state change instruction to change between the two transmission states, wherein
a transition point of the threshold mechanism for a transition from the first to the second transmission state is set independently from a transition point for a transition from the second to the first transmission state.

2. The controller according to claim 1, wherein the transition points are set taking into account a threshold value representing current data load, which is higher if the present transmission state is the first transmission state than if the present transmission state is the second transmission state.

3. The controller according to claim 1, wherein the transition points are set taking into account a state time for which the one or more base stations have been in a present transmission state.

4. The controller according to claim 1, wherein the transition points are set taking into account whether a condition related to the value representing current data load over a period of time is met.

5. The controller according to claim 4, wherein the condition is met when a defined proportion of a defined number of consecutive values representing current data load are at a particular level.

6. The controller according to claim 1, wherein the value representing current data load is calculated by taking a highest measurement of a series of measurements related to the one or more base stations, each measurement representing an amount of user data to be transmitted in a particular time sample.

7. The controller according to claim 1, wherein the value representing current data load incorporates an adjustment, the adjustment being a shift in the magnitude of the value representing current data load prior to application of the threshold mechanism.

8. The controller according to claim 1, wherein the first and second transmission states are any two of more than two transmission states, each of the more than two transmission states having an associated upper capacity limit.

9. The controller according to claim 1, wherein the controller includes a threshold mechanism adaptation unit operable to change the transition points and/or an adjustment, based on a factor in the current network environment, the adjustment being a shift in the magnitude of the value representing current data load prior to application of the threshold mechanism.

10. The controller according to claim 9, wherein the factor is a fraction or amount of current data load having a particular quality of service requirement.

11. A wireless telecommunications system, the telecommunications system including one or more base stations and a controller according to claim 1,
the one or more base stations being operable to wirelessly transmit data to user equipments in a first transmission state having a first capacity and in a second transmission state having a second, higher, capacity; the one or more base stations also being operable to change between these transmission states in response to a transmission state change instruction from the controller.

12. A server or base station including the controller according to claim 1, and being suitable for use in a wireless telecommunications system.

13. A method for use in a controller of a wireless telecommunications system, the telecommunications system including one or more base stations, the one or more base stations being operable to wirelessly transmit data to user equipments in a first transmission state having a first capacity and in a second transmission state having a second, higher, capacity, the one or more base stations also being operable to change between transmission states in response to a transmission state change instruction from the controller;
the method comprising:
applying a threshold mechanism to a value representing current data load, and if the threshold mechanism is satisfied, issuing a transmission state change instruction to change between the two transmission states, wherein,
a transition point of the threshold mechanism for a transition from the first to the second transmission state is set independently from a transition point for a transition from the second to the first transmission state.

14. A method for use in a wireless telecommunications system, the telecommunications system including one or more base stations, wherein
the one or more base stations wirelessly transmit data to user equipments in a first transmission state having a first capacity or in a second transmission state having a second, higher, capacity, and
the controller applies a threshold mechanism to a value representing current data load, and if the threshold mechanism is satisfied, issues a transmission state change instruction to change between the two transmission states, wherein,
a transition point of the threshold mechanism for a transition from the first to the second transmission state is set independently from a transition point for a transition from the second to the first transmission state.

15. A non-transitory storage medium storing a computer program, which, when executed by a computing device, causes the computing device to become the controller according to claim 1.

16. A non-transitory storage medium storing a computer program, which, when executed by a computing device, causes the computing device to become the controller to carry out the method of claim 13.
